(19) United States
(12) Patent Application Publication
(10) Pub. No.: US 2026/0052483 A1
(43) Pub. Date: Feb. 19, 2026

(54) AFC ASSISTED PUNCTURING BASED ON CAPABILITY SIGNALING

(71) Applicant: Cisco Technology, Inc., San Jose, CA (US)

(72) Inventors: Nedime Pelin MOHAMED HASSAN SALEM, San Jose, CA (US); Brian D. HART, Sunnyvale, CA (US); Sachin D. WAKUDKAR, St-Sulpice (CH)

(21) Appl. No.: 19/281,017

(22) Filed: Jul. 25, 2025

Related U.S. Application Data
(60) Provisional application No. 63/682,690, filed on Aug. 13, 2024.

(51) Int. Cl. H04W 52/18; H04L 1/00; H04W 52/30; H04W 72/044

(52) U.S. Cl. CPC H04W 52/18; H04L 1/0068; H04W 52/30; H04W 72/0473

(57) ABSTRACT

An AP is disclosed that identifies which channels (or sub-channels) to puncture when performing low power indoor (LPI) mode using information learned from automated frequency coordination (AFC). An AP that is AFC enabled—i.e., communicates with an AFC operator—can receive AFC information regarding incumbents at the AP's location. The AP can compare the power assignments for the incumbents provided in the AFC response to a threshold to determine whether to perform puncturing on the channel containing the incumbent. That is, the AP can use the threshold to determine whether puncturing the channel containing the incumbent when operating in the LPI mode is likely to negatively impact the incumbent.

### CROSS-REFERENCE TO RELATED APPLICATIONS

This application claims benefit of co-pending U.S. provisional patent application Ser. No. 63/682,690 filed Aug. 13, 2024. The aforementioned related patent application is herein incorporated by reference in its entirety.

### TECHNICAL FIELD

Embodiments presented in this disclosure generally relate to puncturing a sub-channel in a low power indoor (LPI) mode using incumbent information provided by automated frequency coordination (AFC).

### BACKGROUND

Currently, some government regulators do not allow a low power indoor (LPI) access point (AP) to puncture a sub-channel within the 6 MHz band. As an example, consider an LPI-only or simultaneous composite AP (e.g., an AP that can simultaneously support both LPI and standard power (SP) clients using two separate radios) operating an 80 MHz basic service set (BSS) made up of four 20 MHz sub-channels referred to as [P20 S20 S40a S40b]. Assuming there is an incumbent on sub-channel S40a. Puncturing in IEEE 802.11ax/11be (sensing a clear channel on sub-channels P20, S20, and S40b and then transmitting on those sub-channels but not sensing or transmitting on sub-channel S20a) was designed to transmit around the incumbent while avoiding causing interference to the incumbent.

However, some government agents have rejected not performing clear channel assessment (CCA) on the sub-channel containing the incumbent. These agencies believe that puncturing does not protect incumbents due to IEEE 802.11's lack of CCA requirement on punctured sub-channels. Instead, it is required that the LPI APs (and their clients) also perform contention-based channel access, so, given any interference power beyond the sub-channel S20a (even if the interference is not seen in the other sub-channels P20, S20, and S40b), the clients defer and only transmit on the P40 (i.e., the combination of sub-channels P20 and S20) and create one-sided interference which is an improvement over the two-side interference on the incumbent from a P20 S20 and S40b transmission.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a system for using AFC to puncture a sub-channel in LPI, according to one embodiment.

FIG. 2 is a flowchart for puncturing a sub-channel in LPI mode using AFC, according to one embodiment.

FIG. 3 illustrates an AFC response, according to one embodiment.

FIG. 4 is a chart containing an AFC response and a PSD mask, according to one embodiment.

FIG. 5 depicts an example network device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an AP that includes one or more memories and one or more processors communicatively coupled to the one or more memories, wherein the one or more processors are configured to, individually or collectively, perform operations. These operations include receiving, from an AFC operator, maximum permissible power levels the AP is permitted to transmit in a frequency band when operating in standard power (SP) mode, identifying a channel of concern in the frequency band based on the maximum permissible power levels, and upon determining that a maximum permissible power level associated with the channel of concern satisfies a threshold, puncturing the channel of concern when the AP operates in a LPI mode.

Another embodiment presented in this disclosure is a method that includes receiving, from an AFC operator at an AP, maximum permissible power levels the AP is permitted to transmit in a frequency band when operating in SP mode, identifying a channel of concern in the frequency band based on the maximum permissible power levels, and upon determining that a maximum permissible power level associated with the channel of concern satisfies a threshold, puncturing the channel of concern when the AP operates in a LPI mode.

Another embodiment presented in this disclosure is a non-transitory computer readable medium storing instructions that, when executed by one or more processors, cause the one or more processors to, individually or collectively, perform operations. These operations include receiving, from an AFC operator, maximum permissible power levels the AP is permitted to transmit in a frequency band when operating in SP mode, identifying a channel of concern in the frequency band based on the maximum permissible power levels, and upon determining that a maximum permissible power level associated with the channel of concern satisfies a threshold, puncturing the channel of concern when the AP operates in a LPI mode.

### Example Embodiments

Embodiments herein describe an AP that determines, using information learned from AFC, whether a channel (or sub-channel) containing an incumbent can be punctured when performing LPI. Continuing the example above, an AP that is AFC enabled—i.e., communicates with an AFC operator—can receive AFC information regarding incumbents at the AP's location. The AP can compare the power assignments for the incumbents provided in the AFC response to a threshold to determine whether to puncture the channel containing the incumbent. Using the example from above, if the AFC response indicates that there is an incumbent on the sub-channel S20a that has a power assignment (e.g., a (Effective Isotropic Radiated Power (EIRP) Power Spectral Density (PSD)) that is above a threshold, then the AP punctures the sub-channel S20a in the LPI mode. That is, the AP can transmit on the sub-channels on both sides of the punctured sub-channel S20a in the BSS (i.e., sub-channels P20, S20, and S40b). In this manner, the AP can perform puncturing which enables the use of the frequency spectrum on both sides of the punctured sub-channel, in contrast to performing a contention based protocol (e.g., CCA or Dynamic Frequency Selection (DFS) type protocol) on the sub-channel which at most enables the use of the frequency spectrum on one side of the sub-channel containing the incumbent.

There are many different techniques that can be used to set the threshold used to determine whether puncturing can be performed. In one embodiment, the power metric provided by AFC (e.g., the ERIP PSD) can be compared to a transmit (Tx) PSD mask, as defined in IEEE 802.11. If the AFC power assignment is above the PSD mask for the AP, puncturing is permitted. In another embodiment, instead of using the PSD mask as the threshold, the AFC power assignment can be compared to a regulatory maximum EIRP for a SP AP, or the regulatory maximum EIRP for a punctured LPI AP. If the AFC power assignment is greater than or equal to the regulatory maximum EIRP then puncturing is permitted in LPI mode. However, if the AFC power assignment is below the threshold, then the AP does not perform puncturing. In that case, the AP can make a decision based on the environment (e.g., the power needs) and based on the AFC response, such as switching to the SP mode (if the AP is a Simultaneous Composite AP) or remaining in the LPI mode but using contention-based protocols.

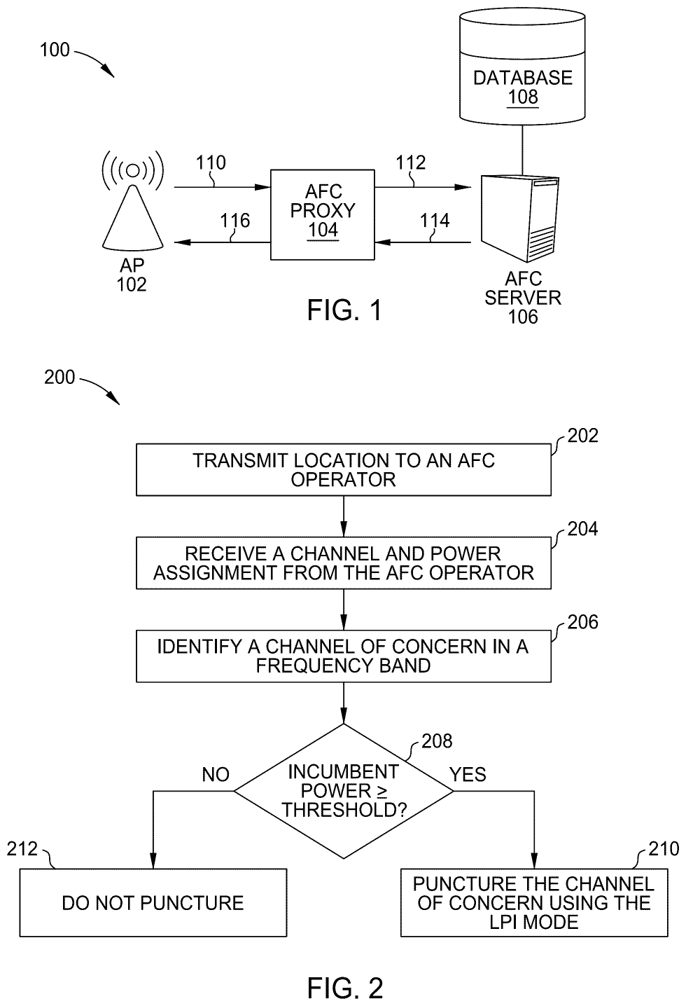

FIG. 1 illustrates a system 100 for using AFC to puncture a sub-channel in LPI, according to one embodiment. FIG. 1 illustrates an AP 102, which can be any AFC-enabled AP. For example, APs that operate in SP mode are AFC enabled. Simultaneous Composite APs can operate in both SP and LPI modes, and thus, are AFC enabled. Typically, any AP that can support the SP mode is also AFC enabled. However, the embodiments herein can be applied to any AP that is AFC enabled, regardless whether that AP supports a SP mode or not.

The AP 102 communicates with (or could include) an AFC proxy 104 that facilitates communication with an AFC server 106 (e.g., a server operated by an AFC operator). AFC is a spectrum management system that ensures Wi-Fi devices operating in the 6 GHz band can do so without interfering with existing licensed users (or fixed services) of the band. The 6 GHz band was previously reserved for licensed services like fixed point-to-point services, Fixed Satellite Services (FSS), Broadcast Auxiliary Services, and Cable Television Relay Services. With the introduction of Wi-Fi 6E and Wi-Fi 7, this band is now available for unlicensed Wi-Fi operation. To prevent Wi-Fi devices from causing interference with these (incumbent) services, regulatory bodies mandate the use of AFC for SP operation in the 6 GHz band, which is generally (but not always) higher power than LPI. AFC systems can include cloud-based databases that contain information about licensed incumbent users of the 6 GHz band, including their locations and operating frequencies.

To perform AFC, the AFC-enabled AP 102 (e.g., a Wi-Fi 6E or Wi-Fi 7 AP) determines its geographical location, potentially using an internal or external GPS module or other types of location services. The AP 102 provides its location and other technical parameters to the AFC proxy 104 as shown by the arrow 110. The AFC proxy 104 queries the AFC server 106, as shown by arrow 112, providing the location and other technical parameters of the AP 102. The AFC server 106 analyzes this information, compares it to a database 108 of licensed users, and calculates which frequencies are available for the AP 102 to use, along with the maximum permissible power levels. These power assignments from the AFC server 106 to the AP 102 can be represented by EIRP PSD measurements.

The AFC server sends a response to the AP proxy as shown by arrow 114, detailing the available frequencies and power limits (i.e., the maximum transmit power levels the AP can operate at to avoid interfering with the incumbents). The AFC proxy 104 can relay this information to the AP 102 as shown by the arrow 116 (or the AFC proxy 104 can be a component—e.g., hardware or software—in the AP 102).

In one embodiment, the AP 102 refreshes its AFC status and re-queries the AFC server 106 regularly (e.g., every 24 hours) to account for any changes in the spectrum landscape or their location. For example, the licensed users and fixed services may be deactivated, or move locations (thereby effecting how much interference the AP 102 may cause), or new licensed users may be added.

The benefits of AFC include enabling higher power Wi-Fi in the case where the AFC server 106 allows SP Wi-Fi APs to transmit at higher power levels (up to 36 dBm EIRP) in the 6 GHz band, both indoors and outdoors, significantly extending range and capacity compared to LPI devices. However, there are situations where the AP 102 can transmit higher power using LPI than when using SP. In that case, the AP 102 will choose to operate as an LPI AP. The embodiments herein provide techniques for the LPI AP (e.g., which can include an AP that only supports LPI, or a simultaneous composite AP) to use AFC to puncture sub-channels when operating in the LPI mode.

FIG. 2 is a flowchart of a method 200 for puncturing a sub-channel in LPI mode using AFC, according to one embodiment. At block 202, the AP transmits a location to an AFC operator. The location can be a GPS location, or a location derived from terrestrial location protocols. For example, the AP can use angle-of-arrival (AoA) of Wi-Fi signals to determine its location relative to other APs, e.g., using AoA-phase measurements to triangulate a device location using several neighboring APs. Or the AP can use a fusion of different location techniques such as a fusion of received signal strength indicator (RSSI)-location computation and AoA-location computation.

The embodiments herein are not limited to any particular technique for identifying the location of the AP. Moreover, in addition to transmitting a location of the AP, the AP can transmit its height to the AFC operator.

At block 204, the AP receives a channel and power assignment from the AFC operator. That is, a response from the AFC operator can assign a power on each channel in a particular band (e.g., the UNII5 and UNII7 bands). The AFC operator queries a database (e.g., the database 108 in FIG. 1) to determine if there are any licensed 6 GHz services (like microwave links or satellite links) in the AP's area. The AFC operator then provides a list of available channels and the corresponding maximum transmit power levels the AP can operate at in the SP mode to avoid interfering with these licensed services. In one embodiment, the AFC response has a granularity of 1 MHz where it indicates the maximum transmit power levels of the AP at each 1 MHz of the spectrum (e.g., the 1200 MHz in the 6 MHz band).

The AFC operator ensures the AP complies with regulations set by regulatory bodies. This is particularly useful for outdoor APs and indoor APs utilizing the extended range functionality of 6 GHz Wi-Fi.

In one embodiment, the AFC operator may provide AFC response regarding certain bands within the spectrum. For example, in the United States, only the UNII5 and UNII7 bands in the 6 GHz frequency band can be used for SP. The UNII6 and UNII8 in the 6 GHz frequency band are for LPI use only (i.e., cannot be used by an AP operating in the SP mode). This is because the UNII6 and UNII8 bands are reserved for mobile licensed user which can move frequently. As such, the AFC operator may not know the current location of the licensed users, which means if it allows an AP to use UNII6 and UNII8 in the SP mode, the AP could interference with these incumbents. As such, in the United States, an SP AP can never use the bands.

However, this many change in the future where AFC may be used to track mobile licensed users. For example, the AFC operator may get locations of the mobile licensed users at frequency intervals (e.g., every minute). An AP that wants to access the UNII6 and UNII8 bands in the SP mode may have to send a query to the AFC every minute to get up to date maximum transmit power levels based on its location, as well as the location of the mobile licensed users. Or the AFC operator may push AFC notifications (with updated maximum transmit power levels) to the AP anytime the location of a mobile license user changes. In that way, in future AFC deployments, it may be possible to also leverage AFC to puncture the UNII6 and UNII8 bands when operating in the LPI mode as discussed below. As such, the embodiments herein are not limited to puncturing only the UNII5 and UNII7 bands when operating in the LPI mode. In general, the techniques herein can be used to puncture any band where AFC has access to a database that stores accurate location information for licensed users and fixed services (i.e., incumbents).

In one embodiment, in order to receive AFC response for other bands besides SP operated bands, the AFC proxy can inform the AFC server of the current operating power mode of the AP (e.g., LPI only, SP only, or simultaneous composite AP) along with the location information when transmitting the AFC query at block 202. The AFC server can use the operating power mode to provide power and channel availability across the 6E bands, and not just the SP operated bands. This way, the AFC server can provide channel and power availability for non-SP operated bands only when it is requested by the AP, thus reducing the impact on compute resources to perform AFC.

In another embodiment, the AFC server uses the current operating power mode as reported by AP to provide max (LPI, SP) power in case the AP is a simultaneous composite AP, which can then be used to determine the maximum allowed power without puncturing, and with puncturing, on a non-punctured portion of a channel. In this way, the AFC server remains the source of truth for available channel and power levels. This information can be used during interference resolution procedure if incumbents complain about interference.

In another embodiment, the AFC proxy transmit a query to the AFC server at block 202 to identify whether there are any incumbents in a defined geographic area (e.g., a polygon of a map). The AFC response at block 204 can indicate whether there are any incumbents in that area. As such, individual queries per AP can be avoided or at least mitigated. If incumbents are found in the area, then further AFC queues can be made with smaller size polygons to identify smaller incumbent impacted areas. Any APs in these areas may not perform any puncturing when operating in the LPI mode (as discussed later in method 200). However, APs outside the smaller incumbent impacted areas can perform puncturing.

At block 206, the AP (or an AFC proxy) identifies a channel of concern in a frequency band on the channel. Put differently, the AP can use the AFC response to identify licensed users and fixed services (i.e., incumbents) which prevent the AP from using a portion of its assigned frequency band. For example, if the AFC response indicates a maximum transmit power levels that is reduced relative to the regulatory limit, then the AP knows there is possibly an incumbent (or multiple incumbents) at that frequency, and thus, this is a channel of concern where if the AP were to transmit on that channel, it might negatively impact the incumbent. Further, AFC may be updated in the future to protect other actors in the 6 GHz band besides incumbents. The embodiments herein can be used to identify any channel of concern using the maximum transmit power levels provided by AFC, whether that because of one incumbent, multiple incumbents, or some other protected device or system.

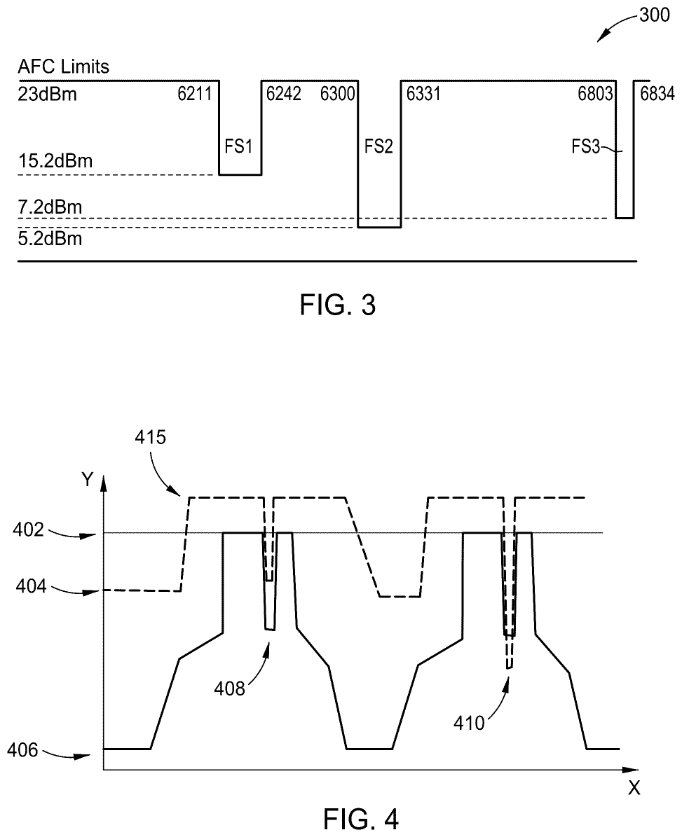

FIG. 3 illustrates an AFC response, according to one embodiment. This chart 300 illustrates the maximum transmit power level at a frequency range within the 6 MHz frequency band. The 23 dBm level is the regulatory maximum for SP. That is, for the frequencies at which the chart 300 is at the 23 dBm level, the AP is able to transmit at the regulatory maximum for SP. In addition, this informs the AP that there are no incumbents at these frequencies.

However, the chart 300 includes several dips that indicate there is an incumbent nearby the AP, and as such, the AP must transmit at reduced power as indicated by the reduced maximum transmit power level. For example, FS1 (e.g., between the frequencies of 6.211 MHz and 6.242 MHZ) indicates a first incumbent, which means the maximum the AP can transmit in the SP mode in this frequency range is 15.2 dBm. At FS2 (e.g., between the frequencies of 6.3 MHz and 6.331 MHZ) there is a second incumbent which may be closer to the AP than the first incumbent, which means the maximum the AP can transmit in the SP mode in this frequency range is even lower—i.e., 5.2 dBm. At FS3 (e.g., between the frequencies of 6.803 MHz and 6.834 MHz) there is a third incumbent which may be slight farther from the AP than the second incumbent but closer than the first incumbent, which means the maximum the AP can transmit in the SP mode at this frequency range is greater than second incumbent but less than the first incumbent—i.e., 7.2 dBm.

In this manner, the channel and power assignments from the AFC response can be used to identify frequency ranges that include incumbents (e.g., the frequency ranges corresponding to FS1, FS2, and FS3) as well as the maximum power the AP can transmit at those frequencies. Notably, as discussed below, the maximum transmit power levels that the AP can use in the SP mode can be used to determine whether the AP can puncture the channels containing incumbents when operating in the LPI mode.

Returning to method 200, after determining the incumbents, at block 208 the AP determines whether the power of the incumbent is greater than a threshold. There are various different strategies for setting the threshold.

In one embodiment, the AFC response includes the EIRP PSD for each 1 MHZ interval in the frequency band. That is, the maximum transmit power levels can be expressed as an EIRP PSD. In that case, the AP can compare the EIRP PSD to the regulatory maximum EIRP for a SP AP. If the EIRP PSD at a particular frequency band (e.g., a 1 MHz interval/band) is less than the regulatory maximum EIRP for the AP, then the AP determines there is an incumbent at that frequency band, and puncturing is not enabled. In other words, in this example, the regulatory maximum EIRP for the SP AP is used as the threshold to determine whether to determine whether to perform puncturing.

In the United States, the fundamental maximum EIRP for 6SD (SP Devices) is defined as 36 dBm. The fundamental power spectral density in any 1-MHz interval/band is 23 dBm/MHz with 6 dB below for 6CD (Dual Client stations). Thus, for a SP AP, the regulatory maximum EIRP is 36 dBm. Thus, in the previous embodiment, the 36 dBm regulatory maximum EIRP for SP devices can be used as the threshold to compare to the EIRP PSD provided by the AFC response.

In one embodiment, the threshold is set to the regulatory maximum EIRP for an unpunctured LPI AP. If the AFC-granted channel EIRP PSD is less than the regulatory maximum EIRP for an unpunctured LPI AP, this means there is an incumbent that may be affected by the LPI AP transmitting at the maximum power permitted by LPI. In that case, the LPI AP does not puncture the channel containing the incumbent. However, if the AFC-granted channel EIRP PSD is equal to or greater than the regulatory maximum EIRP for the unpunctured LPI AP, the puncturing of the channel containing the incumbent is permitted. This embodiment may permit more puncturing than the previous embodiment where the 36 dBm regulatory maximum EIRP for SP devices is used as the threshold to make puncturing decisions.

In the United States, the regulatory maximum EIRP for 6ID (LPI Devices) is defined as 30 dBm. The fundamental power spectral density in any 1-MHz interval/band is 5 dBm/MHz with 6 dB below for 6CD (Dual Client stations). Thus, for an LPI AP, the regulatory maximum EIRP is 30 dBm. In the previous embodiment, the 30 dBm regulatory maximum EIRP for LPI devices can be used as the threshold to compare to the EIRP PSD provided by the AFC response to determine whether to perform puncturing.

In another embodiment, the threshold is set based on radio resource management (RRM) control. If the AFC-granted channel EIRP PSD is less than the EIRP PSD that the LPI AP would use for unpunctured operation (e.g., under RRM control), it means there is an incumbent in the channel that may be affected by the LPI AP transmitting at the maximum power permitted by LPI. In that case, the LPI AP (or a simultaneous composite AP operating in LPI mode) does not puncture that channel. If the AFC-granted channel EIRP PSD equals or exceeds the EIRP PSD that the LPI AP would use (e.g., under RRM control) for unpunctured operation then there is no incumbent (or at least an incumbent that will not be negatively affected by the AP transmitting in the LPI mode) and puncturing by a LPI AP (or a simultaneous composite AP operating in LPI mode) is allowed. Thus, in this example, RRM control as well as the regulatory maximum EIRP for LPI AP and SP AP could be used to set the threshold.

Further, for any of the embodiments above, if there is other interference detected, it may be from unlicensed devices such as Wi-Fi/NRU/etc. so the LPI or simultaneous composite AP may choose to puncture the affected channel.

Regardless which threshold is selected, if the incumbent power (e.g., the power indicated by the EIRP PSD at a particular channel or frequency range) is greater than or equal to the threshold (e.g., satisfies the threshold), then the method proceeds to block 210 where the AP is permitted to puncture the channel of concern (that may contain an incumbent) using the LPI mode. That is, the transmissions of the AP when operating in the LPI mode are unlikely to interfere with the incumbent when the channel that contains the incumbent is punctured. Advantageously, this means the AP can use both sides of the frequency in the BSS (assuming the punctured channel is not at the edges of the BSS) when transmitting, thereby increasing bandwidth (BW). Moreover, the AP does not have to perform any kind of contention-based protocol on the channel containing the incumbent, which can save time.

However, if the incumbent power is less than the threshold, the method proceeds to block 212 where the AP does not puncture the channel containing the incumbent. In that case, there are several actions the AP could perform. For example, the AP may use a contention-based protocol (e.g., CCA or a DFS-like protocol) to determine whether the AP can at least transmit on one side of the channel containing the incumbent, thereby causing at most one-sided interference. Or the AP could switch to the SP mode (if the AP is a simultaneous composite AP) but not use the band that includes the incumbent. In either case, these options may mean less BW is available to the API relative to performing puncturing in the LPI mode.

Advantageously, the method 200 does not require any changes on the client side (i.e., can be performed solely by an LPI or simultaneous composite AP). However, in other embodiments, the client STAs can take part in this process. For example, a STA (AP or client) might be capable of one, or both, of the following: traditional CCA sensing where the STA is capable of sensing around the punctured sub-channel(s) but does not perform CCA for the punctured sub-channel(s), or enhanced CCA sensing where the STA is capable of sensing around the punctured sub-channel(s) and also CCA for the punctured sub-channel(s) at the same or some higher CCA threshold (e.g., 20 dB higher, aligned with the punctured 20 dB depth).

That capability can be leveraged where an LPI/simultaneous composite AP can be permitted to establish a BSS with puncturing even when an incumbent (including an incumbent that can be negatively impacted by the AP transmitting in the LPI mode) is determined to be present. In that case, the AP then signals the CCA requirements to its client STAs (via a field in the Beacon, Probe Response and/or (Re) Association Response frames, such as via 1 bit in the ultra-high reliability (UHR) Operation element) that if no incumbent is present then the AP and the client STAs do not need to perform anything more than traditional CCA before transmitting (within) a punctured physical layer protocol data (PPDU) that initiates a TXOP (and other circumstances where CCA is required).

However, if an incumbent is present, then the AP and the client STA perform enhanced CCA before transmitting (within) a punctured PPDU that initiates a TXOP (and other circumstances where CCA is required). In one embodiment, only client STAs that support the required CCA behavior are permitted to associate (or operate at) the full BW (that includes punctured channels); otherwise, the client STAs join at (or operate at) a lower BW that is, e.g., entirely unpunctured.

In other embodiments, as part of the enhanced CCA described above, a simultaneous composite STA determines if the AP (or is told by a client STA) a CCA factor rho (p) based on the channel power (P_ch) that is reported in the AFC response.

The following is an example of how the CCA factor ρ can be assigned with relation to P_ch:

$$If P\_ch = 36 dBm then rho = 0 ,$$

$$If 33 dBm < P\_ch < 36 dBm then rho = 0.2$$

$$If 30 dBm < P\_ch < 33 dBm then rho = 0.4$$

$$If 27 dBm < P\_ch < 30 dBm then rho = 0.6$$

$$If 24 dBm < P\_ch < 27 dBm then rho = 0.8$$

$$If 24 dBm > P\_ch then rho = 1$$

In one embodiment, a STA (AP or client) performs CCA sensing over both punctured and unpunctured channels. In this case, the STA gets no CCA relaxation over any punctured channel.

In other embodiments, a STA (AP or client) can get CCA relaxation based on AFC prescribed power level identified through AFC queries across each of the LPI/SP bands over both punctured and unpunctured channels.

In other embodiments, the AP enforces enhanced CCA by rejecting association (or using a membership selector or deauthentication protocols, etc.) if client STAs are incapable of enhanced CCA. Signaling bits can be used to perform STA classification and recognition for rejecting association request from client STA with insufficient capability to perform the enhanced CCA.

FIG. 4 is a chart containing an AFC response and a PSD mask, according to one embodiment. In this example, plot 404 is the AFC response which indicates the maximum transmit power levels of the AP (y-axis) across a frequency range (x-axis). When plot 404 of the AFC response is at the maximum (e.g., at level 415), this indicates the AP can transmit at the maximum regulatory power for SP mode (e.g., 23 dBm).

Plot 402 is the maximum amount of power a LPI STA (AP or client) can transmit (with CCA). Thus, at some points of time, due to incumbents, the plot 404 of the AFC response dips below the plot 402, indicating a channel where, because of the threat of affecting an incumbent, the AP is not permitted to transmit at the maximum LPI power shown by plot 402.

Plot 406 is the PSD mask, which in this example is based on an IEEE punctured Tx PSD mask. The PSD mask is used as the threshold (e.g., the threshold discussed at block 208 of FIG. 2) for determining whether to puncture the channel containing the incumbent. As such, in this example, the threshold changes or fluctuates depending on the frequency, as shown by the plot 406.

In one embodiment, the AP reports to non-AP STAs their AFC-permitted powers in the punctured channels, e.g., via TPE elements. Current TPEs for a simultaneous composite AP include max (LPI, SP). However, for a channel punctured due to an incumbent (and without CCA), LPI is not applicable so the AP may only report permitted SP power. However, some LPI client STAs do not follow the TPE elements sent by a simultaneous composite AP (they rely on their own regulatory knowledge). Nonetheless, the AP can help the LPI client STAs to meet their regulations.

To do so, because LPI client STAs sending punctured PPDUs still should meet the PSD mask shown in plot 406, then the AP may enable puncturing in the simultaneous composite AP if the plot 404 for the AFC response remains above the plot 406 of the PSD mask.

FIG. 4 illustrates a dip 408 and a dip 410 in the AFC response that corresponds to two incumbents. At dip 408, the AFC response remains above the PSD mask. As such, the AP can enable puncturing on this channel. However, at dip 410, the plot 404 for the AFC response falls below the plot 406 of the PSD mask. There, the AP does not permit puncturing the channel with the incumbent which helps ensure LPI client STAs will meet their regulations. In this manner, an AP can take steps when deciding whether to puncture a channel containing an incumbent so that client STAs satisfy their regulatory requirements.

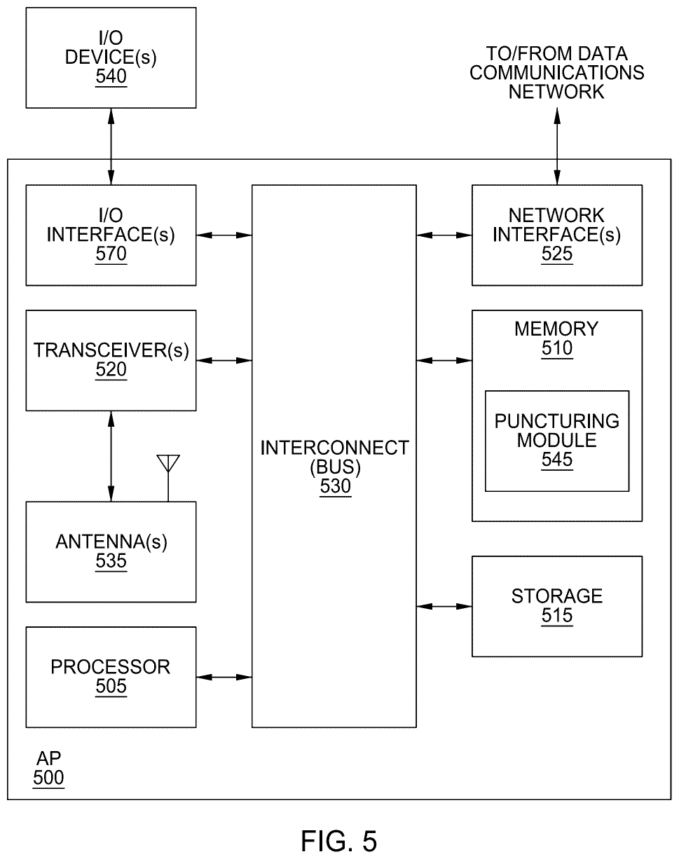

FIG. 5 depicts an example network device 500 configured to perform various aspects of the present disclosure, according to some aspects of the present disclosure. The network device 500 may be an AP, which corresponds to the AP 102 as depicted in FIG. 1, or to a client STA.

As illustrated, the example network device 500 includes a processor 505 (or processors), memory 510 (or memories), storage 515, one or more transceivers 520, one or more I/O interfaces 570, and one or more network interfaces 525. In some embodiments, I/O devices 540 are connected via the I/O interface(s) 570. Further, via the network interface 525, the network device 500 can be communicatively coupled with one or more other devices and components (e.g., via a network, which may include the Internet, local network(s), and the like). Each of the components is communicatively coupled by one or more buses 530. In some embodiments, one or more antennas 535 may be coupled to the transceivers 520 for transmitting and receiving wireless signals.

The processor 505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 505 processes information received through the transceiver 520, I/O interfaces 570, and the network interfaces 525. The processor 505 retrieves and executes programming instructions stored in memory 510, as well as stores and retrieves application data residing in storage 515.

The storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 515 may store a variety of data for the efficient functioning of the system.

The memory 510 may include random access memory (RAM) and read-only memory (ROM). The memory 510 may store processor-executable software code containing instructions that, when executed by the processor 505, enable the network device 500 to perform various functions described herein for wireless communication. In the illustrated example, the memory 510 includes a software component: a puncturing module 545.

In one embodiment, the puncturing module 545 decides when to puncture a channel containing an incumbent when operating in LPI mode using information contained in an AFC response. For example, the puncturing module 545 may perform any of the operations discussed above in FIGS. 2-4. Moreover, the puncturing module 545 be part of an AFC proxy (e.g., the AFC proxy 104) if the AFC proxy is disposed on the AP.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point (AP) comprising:
one or more memories; and
one or more processors communicatively coupled to the one or more memories, wherein the one or more processors are configured to, individually or collectively, perform operations comprising:
receiving, from an Automated Frequency Coordination (AFC) operator, maximum permissible power levels the AP is permitted to transmit in a frequency band when operating in standard power (SP) mode;
identifying a channel of concern in the frequency band based on the maximum permissible power levels; and
upon determining that a maximum permissible power level associated with the channel of concern satisfies a threshold, puncturing the channel of concern when the AP operates in a low power indoor (LPI) mode.

2. The AP of claim 1, wherein the threshold is set based on a regulatory maximum Effective Isotropic Radiated Power (EIRP) for a Standard Power AP and wherein the threshold is satisfied when the maximum permissible power level is equal to or greater than the threshold.

3. The AP of claim 1, wherein the threshold is set based on a regulatory maximum Effective Isotropic Radiated Power (EIRP) for a LPI AP and wherein the threshold is satisfied when the maximum permissible power level equals or exceeds the threshold.

4. The AP of claim 1, wherein the threshold is determined based on Radio Resource Management (RRM) and wherein the threshold is satisfied when the maximum permissible power level equals or exceeds the threshold.

5. The AP of claim 1, wherein the threshold changes based on frequency.

6. The AP of claim 5, wherein the threshold is determined based on a Power Spectral Density (PSD) mask, wherein the threshold is satisfied when the maximum permissible power level equals or exceeds the threshold.

7. The AP of claim 1, wherein determining that the maximum permissible power level associated with the channel of concern satisfies the threshold indicates that the AP will not negatively impact an incumbent when operating in the LPI mode and when puncturing the channel of concern containing the incumbent.

8. The AP of claim 1, wherein the AP supports both LPI and standard power (SP) modes of operation.

9. The AP of claim 1, wherein the AP only supports LPI mode of operation.

10. A method comprising:
receiving, from an Automated Frequency Coordination (AFC) operator at an access point (AP), maximum permissible power levels the AP is permitted to transmit in a frequency band when operating in standard power (SP) mode;
identifying a channel of concern in the frequency band based on the maximum permissible power levels; and
upon determining that a maximum permissible power level associated with the channel of concern satisfies a threshold, puncturing the channel of concern when the AP operates in a low power indoor (LPI) mode.

11. The method of claim 10, wherein the threshold is set based on a regulatory maximum Effective Isotropic Radiated Power (EIRP) for a Standard Power AP and wherein the threshold is satisfied when the maximum permissible power level is equal to or greater than the threshold.

12. The method of claim 10, wherein the threshold is set based on a regulatory maximum Effective Isotropic Radiated Power (EIRP) for a LPI AP and wherein the threshold is satisfied when the maximum permissible power level equals or exceeds the threshold.

13. The method of claim 10, wherein the threshold is determined based on Radio Resource Management (RRM) and wherein the threshold is satisfied when the maximum permissible power level equals or exceeds the threshold.

14. The method of claim 10, wherein the threshold changes based on frequency.

15. The method of claim 14, wherein the threshold is determined based on a Power Spectral Density (PSD) mask, wherein the threshold is satisfied when the maximum permissible power level equals or exceeds the threshold.

16. A non-transitory computer readable medium storing instructions that, when executed by one or more processors, cause the one or more processors to, individually or collectively, perform an operation, the operation comprising:
receiving, from an Automated Frequency Coordination (AFC) operator at an access point (AP), maximum permissible power levels the AP is permitted to transmit in a frequency band when operating in standard power (SP) mode;
identifying a channel of concern in the frequency band based on the maximum permissible power levels; and
upon determining that a maximum permissible power level associated with the channel of concern satisfies a threshold, puncturing the channel of concern when the AP operates in a low power indoor (LPI) mode.

17. The non-transitory computer readable medium of claim 16, wherein the threshold is set based on a regulatory maximum Effective Isotropic Radiated Power (EIRP) for a Standard Power AP and wherein the threshold is satisfied when the maximum permissible power level is equal to or greater than the threshold.

18. The non-transitory computer readable medium of claim 16, wherein the threshold is set based on a regulatory maximum Effective Isotropic Radiated Power (EIRP) for a LPI AP and wherein the threshold is satisfied when the maximum permissible power level equals or exceeds the threshold.

19. The non-transitory computer readable medium of claim 16, wherein the threshold is determined based on Radio Resource Management (RRM) and wherein the threshold is satisfied when the maximum permissible power level equals or exceeds the threshold.

20. The non-transitory computer readable medium of claim 16, wherein the threshold is determined based on a Power Spectral Density (PSD) mask, wherein the threshold is satisfied when the maximum permissible power level equals or exceeds the threshold.
